(19) United States
(12) Patent Application Publication
(10) Pub. No.: US 2005/0105440 A1
(43) Pub. Date: May 19, 2005

(54) Disk apparatus and disk reproducing method

(75) Inventors: Koichi Otake, Yokohama-shi (JP); Hideyuki Yamakawa, Kawasaki-shi (JP); Yukiyasu Tatsuzawa, Yokohama-shi (JP); Hiroyuki Moro, Ome-shi (JP); Toshihiko Kaneshige, Yokohama-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/990,522

(22) Filed: Nov. 18, 2004

(30) Foreign Application Priority Data
Nov. 19, 2003 (JP) 2003-389708

(51) Int. Cl. G11B 5/09

(52) U.S. Cl. 369/59.23; 369/47.21

(57) ABSTRACT

A disk apparatus has a reading portion which reads out a plurality of frames stored in a disk and outputs a read signal, a detecting portion which determines that part of the read signal is identical to a frame synchronization code signal or determines that a deviation between a symbol of part of the read signal and a symbol of the frame synchronization code signal is within a certain time range to detect the frame synchronization code signals from the read signal, and a reproducing portion which reproduces the read signal in synchronization with the detected frame synchronization code signals.

### CROSS-REFERENCE TO RELATED APPLICATIONS

This application is based upon and claims the benefit of priority from prior Japanese Patent Application No. 2003-389708, filed Nov. 19, 2003, the entire contents of which are incorporated herein by reference.

### BACKGROUND OF THE INVENTION

1. Field of the Invention

The present invention relates to a disk apparatus, and particularly to a disk apparatus and disk reproducing method for detecting frame synchronization code signals and performing reproduction processing in synchronization therewith.

2. Description of the Related Art

As well known, in recent years, an optical disk has been remarkably spread as an information medium for digital data, and data is added with an error correction code or an ID for data identification and divided into blocks (sectors) in predetermined unit to be recorded in the information medium such as optical disk. Here, one sector is further divided into frames and a frame synchronization code signal for synchronizing with a frame is inserted into each frame.

Therefore, in a reproduction processing in the optical disk apparatus, a synchronization signal is detected from a read signal from a recording medium. Then, arrangement information of data blocks is obtained by division and demodulation of data in symbols as well as order information from the synchronization signal with a position of the synchronization signal as a starting point, so that error correction processing and the like are performed to recover a reproduction signal. In this manner, since it is an assumption that synchronization signals are correctly detected in order to reproduce data, it is important to accurately detect the synchronization signals.

In a prior art of such optical disk apparatus (Jpn. Pat. Appln. KOKAI Publication No. 9-98371), a synchronization signal detecting circuit used in the optical disk apparatus is shown, where a read signal is proposed to be detected as a synchronization signal if it is within a Hamming distance set using the Hamming distance for calculation. According to this method, a pattern different from a normal pattern can be recognized as the synchronization signal.

However, in the prior art, since only the Hamming distance used here is a determination reference so that a signal apparently irrelevant to the synchronization signal is erroneously detected as the synchronization signal, there is a problem that a reproduction processing is interrupted since synchronization cannot be established in the reproduction processing.

### BRIEF SUMMARY OF THE INVENTION

According to one aspect of the present invention, there is provided a disk apparatus comprising: a reading portion which reads out frame synchronization codes and main data stored in a disk to output a read signal; a detecting portion which determines that part of the read signal is identical to a frame synchronization code signal or determines that a deviation between a symbol of part of the read signal and a symbol of the frame synchronization code signal is within a certain time range, so as to detect the frame synchronization code signals from the read signal; and a reproducing portion which reproduces the read signal read by the reading portion in synchronization with the frame synchronization code signals detected by the detecting portion.

### BRIEF DESCRIPTION OF THE SEVERAL VIEWS OF THE DRAWING

FIG. 1 is a block diagram showing one example of a structure of an optical disk apparatus according to the present invention;

FIG. 2 is a block diagram showing one example of a structure of a synchronization detecting portion in the optical disk apparatus according to the present invention;

FIG. 3 is a diagram showing one example of a truth value table indicating an operation of a pattern match circuit of the synchronization detecting portion in the optical disk apparatus according to the present invention;

FIG. 4 is a diagram showing another example of the truth value table indicating the operation of the pattern match circuit of the synchronization detecting portion in the optical disk apparatus according to the present invention;

FIG. 5 is a diagram showing one example of a structure of a sector of a high-density optical disk handled by the optical disk apparatus according to the present invention;

FIG. 6 is a diagram showing one example of a synchronization code used in the optical disk apparatus according to the present invention;

FIG. 7 is a diagram showing how a waveform of the longest pattern contained in the synchronization code used in the optical disk apparatus according to the present invention is varied and recognized as a different pattern;

FIG. 8 is a diagram showing one example of a specifically fallible pattern in the high-density optical disk handled by the optical disk apparatus according to the present invention;

FIG. 9 is a diagram showing-another example of the specifically fallible pattern in the high-density optical disk handled by the optical disk apparatus according to the present invention;

FIG. 10 is a diagram showing still another example of the specifically fallible pattern in the high-density optical disk handled by the optical disk apparatus according to the present invention;

FIG. 11 is a flowchart showing one example of an operation of determining a reference value of the synchronization detecting portion in the optical disk apparatus according to the present invention;

FIG. 12 is a flowchart showing one example of the operation of determining a reference value of the synchronization detecting portion in the optical disk apparatus according to the present invention; and

FIG. 13 is an explanatory diagram showing information in a control data area used for the operation of determining a reference value of the synchronization detecting portion in the optical disk apparatus according to the present invention.

### DETAILED DESCRIPTION OF THE INVENTION

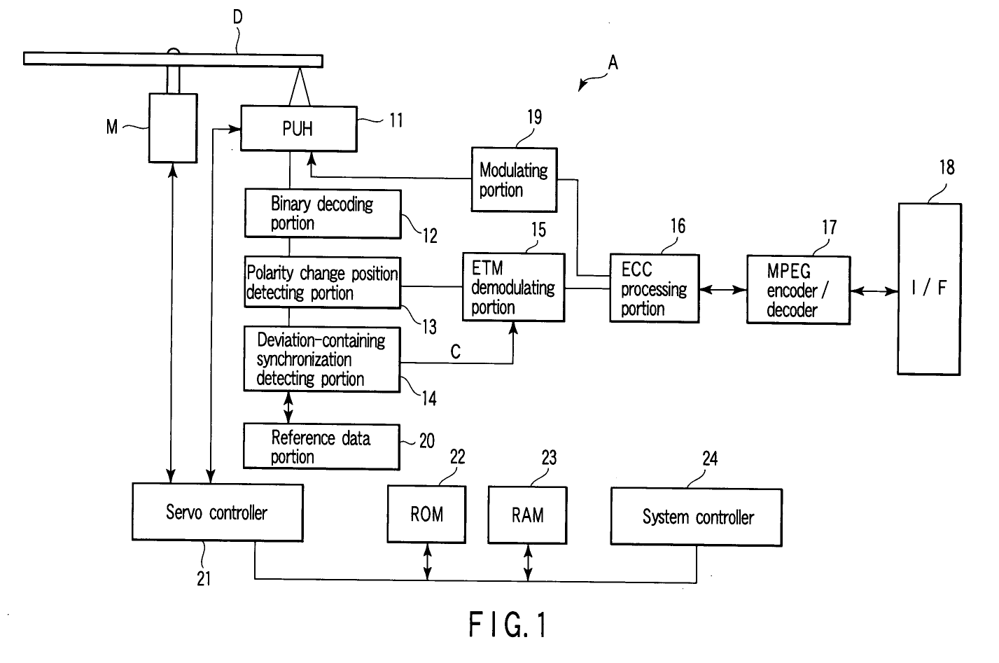

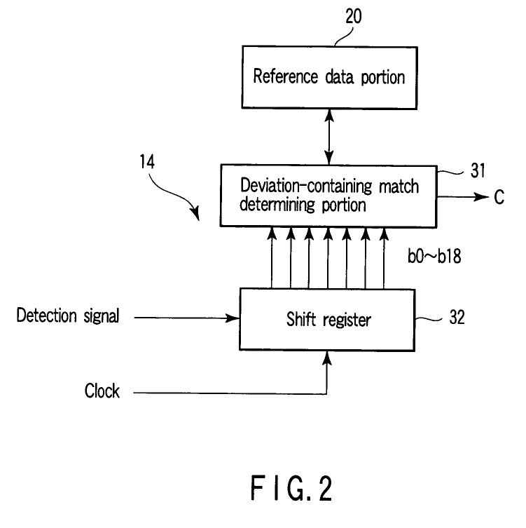

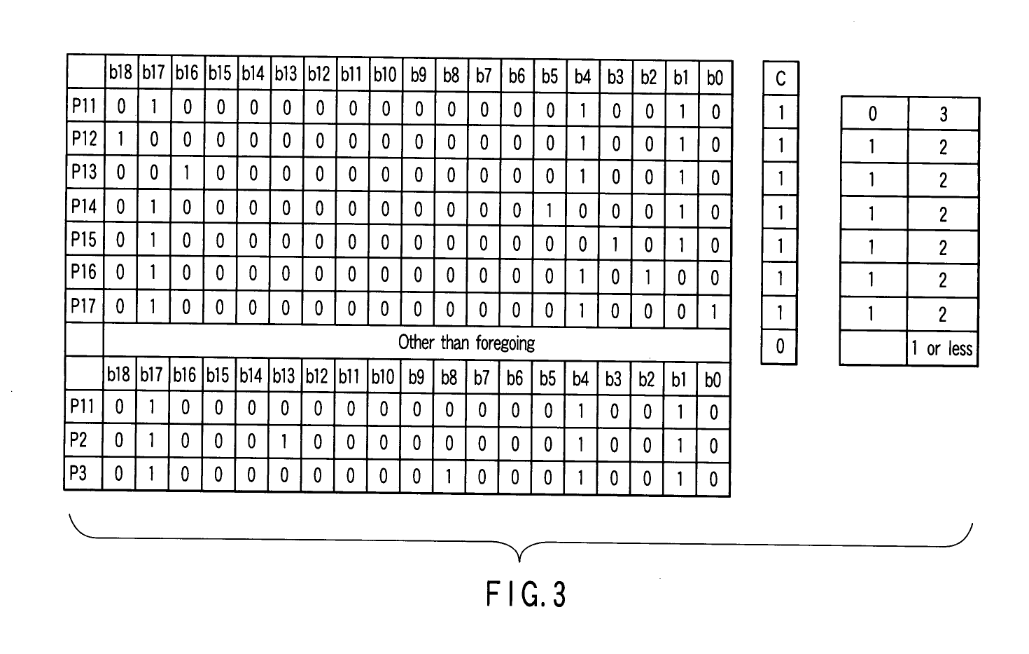

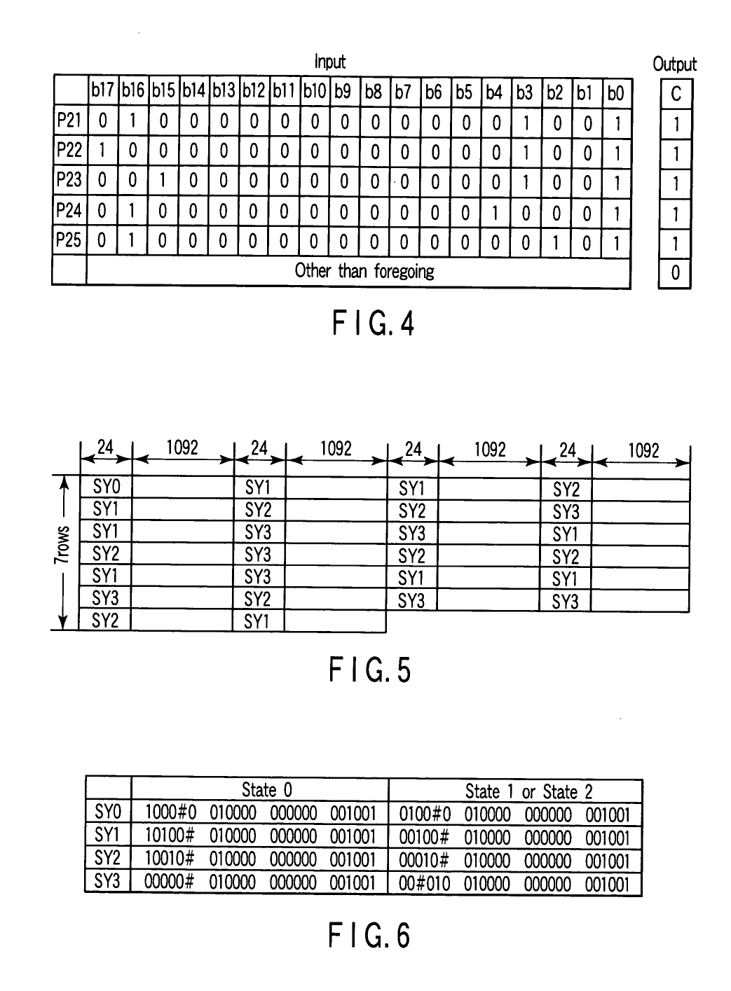

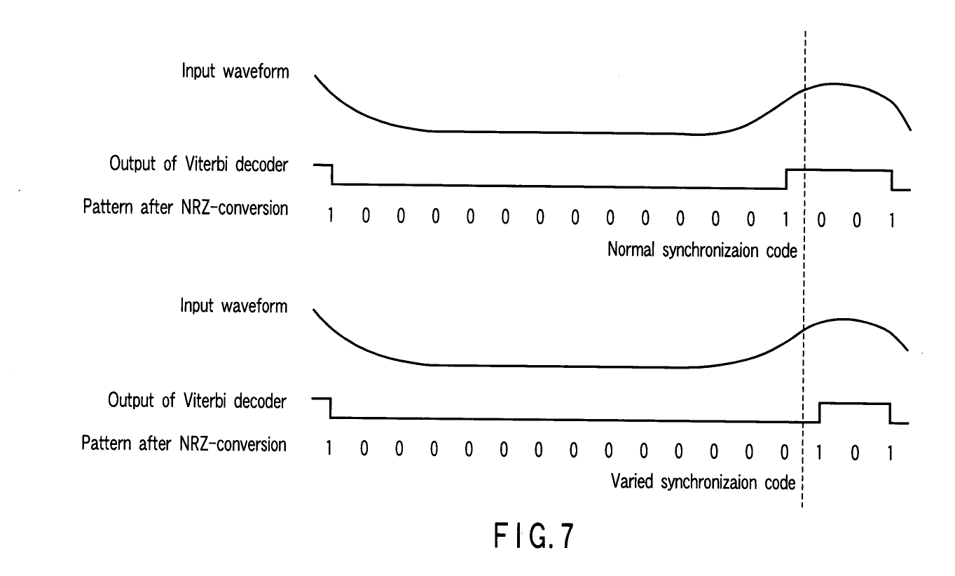

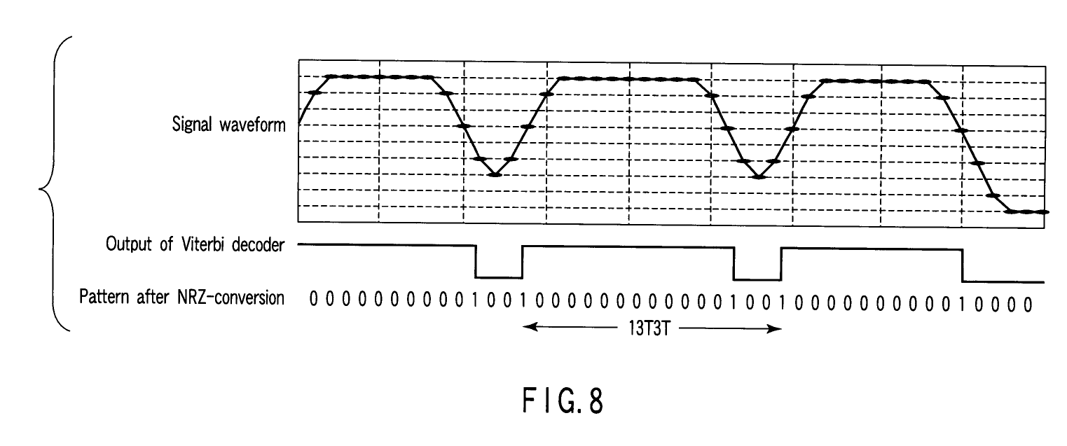

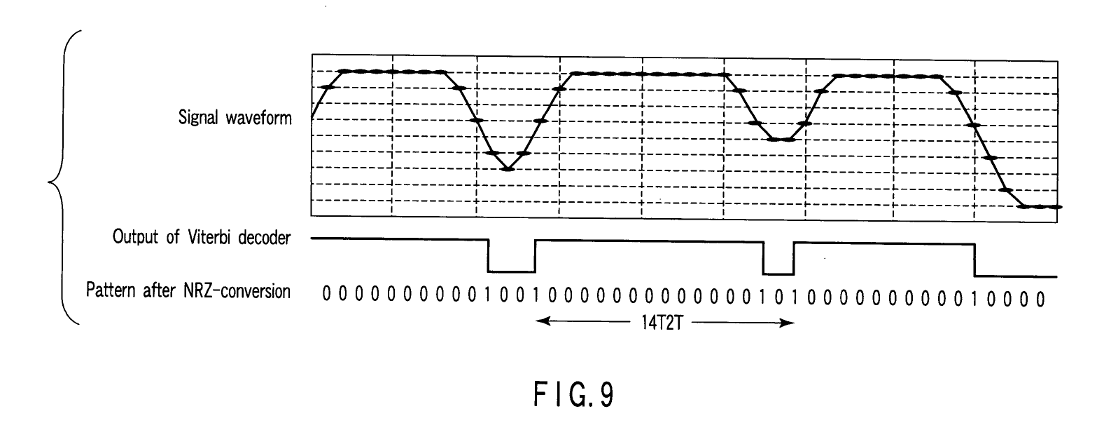

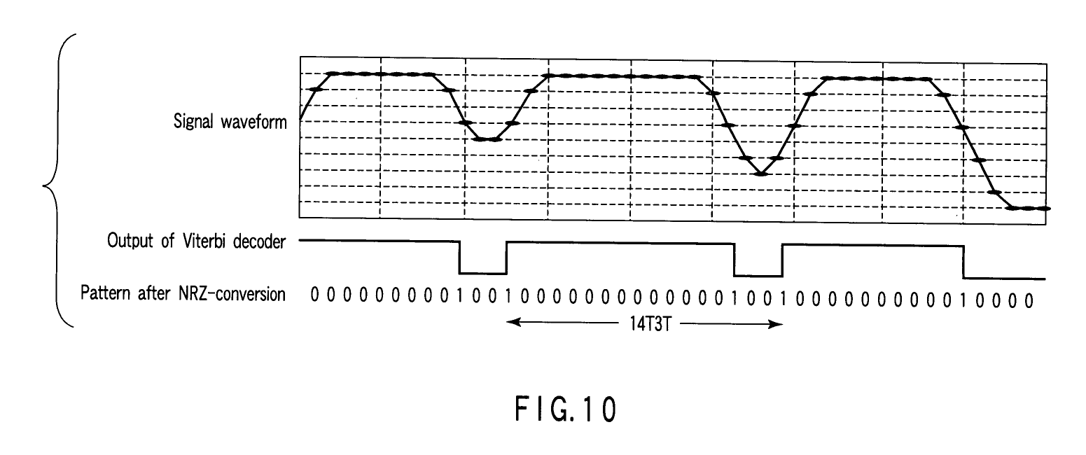

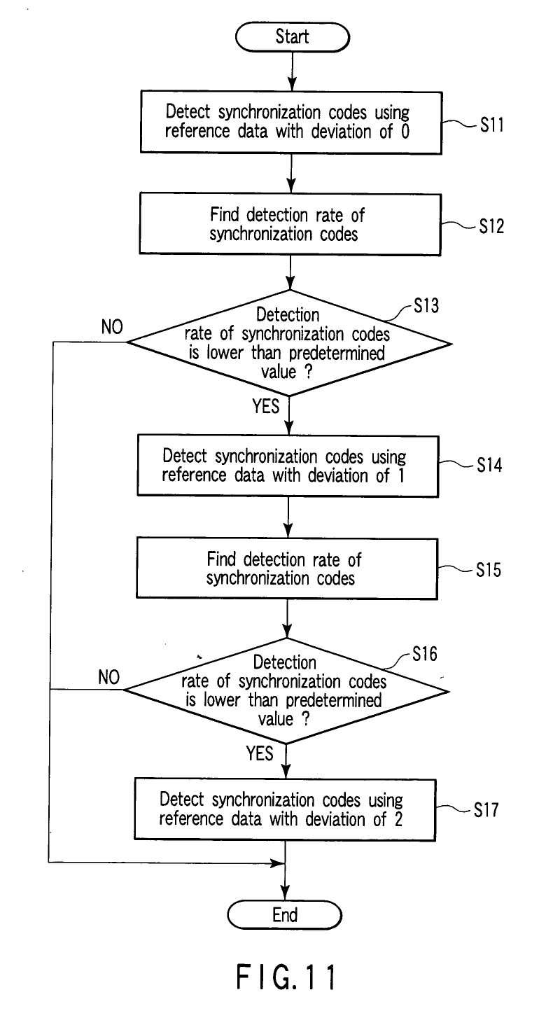

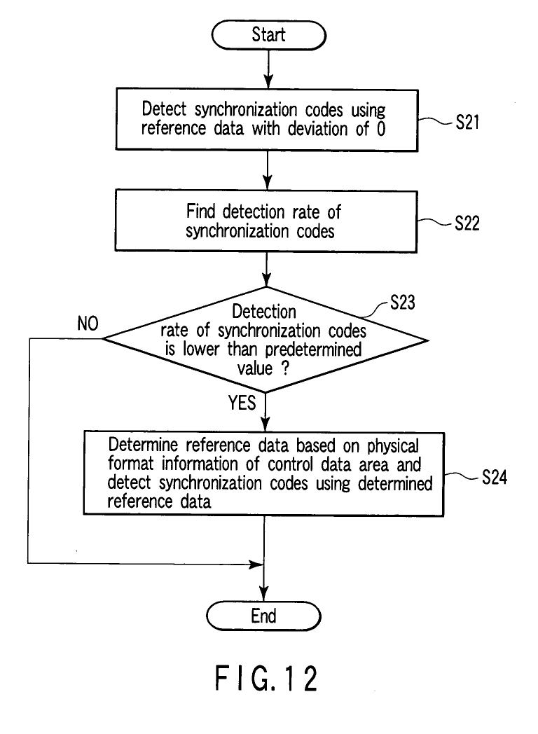

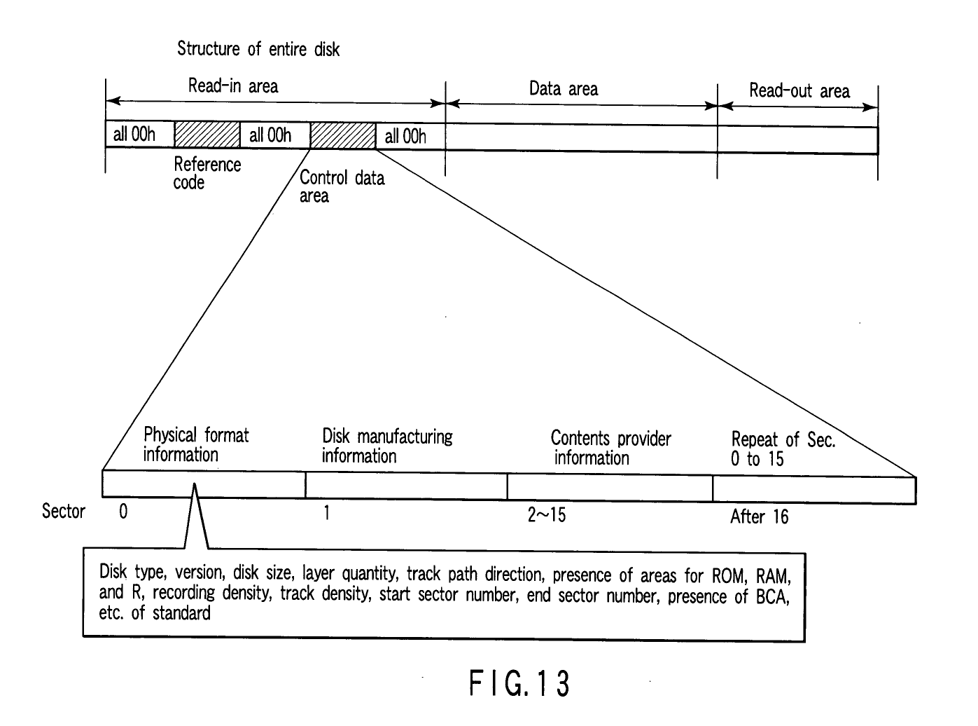

An embodiment according to the present invention will be described below in detail with reference to the drawings. FIG. 1 is a block diagram showing one example of a structure of an optical disk apparatus according to the present invention, FIG. 2 is a block diagram showing one example of a structure of a synchronization detecting portion in the optical disk apparatus according to the present invention, FIG. 3 is a diagram showing one example of a truth value table indicating an operation of a pattern match circuit of the synchronization detecting portion in the optical disk apparatus according to the present invention, FIG. 4 is a diagram showing another example of the truth value table indicating the operation of the pattern match circuit of the synchronization detecting portion in the optical disk apparatus according to the present invention, FIG. 5 is a diagram showing one example of a structure of a sector of a high-density optical disk handled by the optical disk apparatus according to the present invention, FIG. 6 is a diagram showing one example of a synchronization code used in the optical disk apparatus according to the present invention, FIG. 7 is a diagram showing how a waveform of the longest pattern contained in the synchronization code used in the optical disk apparatus according to the present invention is varied and recognized as a different pattern, FIG. 8 is a diagram showing one example of a specifically fallible pattern in the high-density optical disk handled by the optical disk apparatus according to the present invention, FIG. 9 is a diagram showing another example of the specifically fallible pattern in the high-density optical disk handled by the optical disk apparatus according to the present invention, FIG. 10 is a diagram showing still another example of the specifically fallible pattern in the high-density optical disk handled by the optical disk apparatus according to the present invention, FIG. 11 is a flowchart showing one example of an operation of determining a reference value of the synchronization detecting portion in the optical disk apparatus according to the present invention, FIG. 12 is a flowchart showing one example of the operation of determining a reference value of the synchronization detecting portion in the optical disk apparatus according to the present invention, and FIG. 13 is an explanatory diagram showing information in a control data area used for the operation of determining a reference value of the synchronization detecting portion in the optical disk apparatus according to the present invention.

<Optical Disk Apparatus According to the Present Invention>

(Structure)

An optical disk apparatus A according to the present invention has a spindle motor M which rotates at a predetermined frequency while holding an optical disk D, a pickup head 11 which irradiates a laser light on this optical disk D and receives a reflected light to supply a read signal, a binary decoding portion 12 which receives the read signal from the pickup head 11 and decodes it to a binary signal, and a polarity change position detecting portion 13 which detects a position where a sign of this binary signal is inverted. Further, the optical disk apparatus A has a deviation-containing synchronization detecting portion 14 which is a characteristic of the present invention, an ETM decoding portion 15 connected thereto, and a reference data portion 20 which is a storage area for storing reference data. Furthermore, the optical disk apparatus A has an ECC (Error Correction Code) circuit 16 which receives a decoded output signal from the ETM decoding portion 15 and performs a processing of error-correcting the signal, a MPEG encoder/decoder 17 which performs MPEG (Moving Picture Experts Group) decoding on the error-corrected signal or performs MPEG encoding on a signal given in recording processing, and an interface 18 connected thereto which mediates a signal to an external device. Furthermore, the optical disk apparatus A has a modulating portion 19 which is connected to the ECC processing portion 16 and performs modulation processing on a signal recorded in recording processing.

Further, the optical disk apparatus A has a system controller 24 which performs an entire control operation, and a ROM 22 and a RAM 23 both connected thereto, which are connected to a servo controller 21 which controls the frequency of the spindle motor M or the operation of the pickup head 11.

(Operation)

Next, an operation of the optical disk apparatus A according to the present invention will be described. The operation of the optical disk apparatus A according to the present invention will be described below in detail by way of an example of an optical disk apparatus on which an optical disk such as DVD (Digital Versatile Disc) is mounted and which reproduces stored recording information or records desired video information on a recording medium such as DVD-RAM (Random Access Memory). However, an operation of the deviation-containing synchronization detecting portion 14 which is a characteristic of the present invention relates to a reproduction processing of the optical disk and is effective for an optical disk reproducing-only apparatus.

An operation of the reproduction processing in the optical disk apparatus A according to the present invention will be described. When an optical disk D such as DVD is rotated by the spindle motor M at a predetermined frequency and receives a laser light from the pickup head 11 and a reflected light thereof is received by the pickup head 11, the pickup head 11 supplies a read signal corresponding to the reflected light to the binary decoding portion 12. A binary signal from the binary decoding portion 12 is supplied to the polarity change position detecting portion 13 and a polarity change position signal is supplied to the ETM decoding portion 15.

The binary signal from the binary decoding portion 12 is also supplied to the deviation-containing synchronization detecting portion 14, and the deviation-containing synchronization detecting portion 14 detects a frame synchronization code signal from the binary signal and supplies it to the ETM decoding portion 15 while referring to reference data from the reference data portion 20. The ETM decoding portion 15 recognizes a frame position of the read signal according to the supplied frame synchronization code signal to perform a processing of decoding the read signal, and supplies the decoded signal to the ECC processing portion 16. The ECC processing portion 16 detects an error signal of the decoded signal and recovers the same, and supplies it to the MPEG decoder 17. The MPEG decoder 17 decodes the decoded signal to generate a reproducible video signal, and outputs it to an external monitor apparatus, for example, via the interface 18.

(Deviation-containing Synchronization Detecting Portion According to the Present Invention)

An operation of the aforementioned deviation-containing synchronization detecting portion 14 will be described below in detail with reference to the drawing. The deviation-containing synchronization detecting portion 14 according to the present invention accurately detects a frame synchronization code signal deviated by one symbol in timing, for example, and has a structure and operation described later. Thus, a general recording signal irrelevant to the frame synchronization code signal is not erroneously detected by the conventional synchronization detection using the Hamming distance, for example, and only normal frame synchronization code signals and frame synchronization code signals having a certain deviation can be accurately detected.

In other words, the deviation-containing synchronization detecting portion 14 according to the present invention has a structure shown in FIG. 2, for example, and is connected to the reference data portion 20 which stores the reference data in the storage area, and further has a deviation-containing match determining portion 31 and a shift register 32. The shift register 32 is supplied with a read signal from the binary decoding portion 12, and is further supplied with a system clock signal. Then, the shift register 32 accurately detects a frame synchronization code signal C from the read signal according to the operation described later, and supplies it to the ETM decoding portion 15, for example.

(Pattern Frame Synchronization Code Signal)

Next, a pattern frame synchronization code signal to be detected by the deviation-containing synchronization detecting portion according to the present invention will be described. An optical disk generally representative of DVD forms spiral-shape tracks on a circular recording medium, and records data on the tracks. Data on each track is composed of several items of data (sectors) in predetermined units. The recorded data on each sector is further divided for predetermined data (frame). The frame is composed of a synchronization code for synchronizing with data, and main data modulated in the (d, k; m, n) modulation rule.

FIG. 5 shows a structure of a sector used in a high-density optical disk. One frame is composed of a 24-bit synchronization code and 1092-bit main data, and one sector is composed of 26 frames. Each frame is added with four types of synchronization codes of SY0 to SY3. The synchronization codes are detected to extract frame delimiters and SY0 to SY3 contained in the consecutive three frames are identified to extract frame numbers in the sector. Thus, the synchronization code contains a unique pattern which does not appear in the main data and a part for identifying the synchronization type.

FIG. 6 shows an example of the synchronization code used in the high-density optical disk. Each synchronization code is composed of 24 bits, where the leading 7 bits are allocated to a pattern for specifying the type of the synchronization code, and the remaining 17 bits are allocated to the common unique pattern. Two types of synchronization codes are present for SY0, SY1, SY2, and SY3, respectively, and either one of the two is selected depending on State indicated by the immediately previous data according to the modulation rule. “#” in the synchronization code is a bit arbitrarily selected for adjusting a DSV (Digital Sum Value) of the entire signal.

The pattern of these synchronization codes contains a unique pattern of “10000000000001001” as common part. When this pattern is indicated by an interval between the symbols “1”s, it is also called 13T3T pattern. Here, “T” is a unit for indicating a length of one symbol. When actually recoding in the recording medium, a recording bit is inverted at the position of the symbol “1”.

(Variant of Pattern Frame Synchronization Code Signal)

A varied pattern frame synchronization code signal to be detected by the deviation-containing synchronization detecting portion according to the present invention will be described with reference to the drawings. As a method for further improving a recording density in a next-generation DVD, there is a method for changing to a modulation system of d=1 and utilizing PRML (Partial Response Maximum Likelihood) for the binary decoding portion 12, for example. When the method is employed, a reproduction pattern may be varied before and after the longest pattern contained in the synchronization code when a reproduction state is not preferable such as when asymmetry is large, waveform equalization is insufficient, or a CD offset remains.

FIG. 7 shows how the waveform of the longest pattern contained in the synchronization code is recognized as a different pattern. An input waveform is assumed to be a binary NRZI code through a Viterbi decoder (output of the Viterbi decoder). Further, the inverting position is converted into a NRZ code whose symbol is “1” (pattern after NRZ-conversion). Amplitude of a short pattern such as “1001” is originally short, and a waveform thereof is easily changed due to an influence by a long pattern.

FIGS. 8 to 10 show an example of a specifically fallible pattern in the high-density optical disk. FIG. 8 shows a signal waveform before and after the synchronization code, an output of the Viterbi decoder, and a pattern after NRZ-conversion when “#” is assumed as 0 for the synchronization code of State 1 of SY3 in FIG. 6. The signal waveform assumes a case using PR (1, 2, 2, 2, 1).

As a characteristic of the high-density optical disk, amplitude of a short pattern such as 2T or 3T is remarkably small. Thus, when a long pattern is arranged before or after the short pattern, the short pattern has a tendency to be easily influenced by a polarity of the long pattern. The tendency is remarkable especially before and after 13T contained in the synchronization code. Similarly, FIG. 9 shows an example where the short pattern after 13T breaks to be 14T2T, and FIG. 10 shows an example where the short pattern before 13T breaks to be 14T3T.

(Detecting Operation)

An operation of detecting the frame synchronization code signal C in the deviation-containing synchronization detecting portion 14 according to the present invention will be described in detail with reference to the drawings.

Hereinafter, an example using “10000000000001001” as a unique pattern will be shown. The shift register 32 in the deviation-containing synchronization detecting portion 14 in FIG. 2 shifts an input serial signal which is a read signal by one bit for each clock, and outputs parallel data b0 to b18. Here, the shift register is expanded by 2 bits to output 19-bit parallel data.

The deviation-containing match determining portion 31 compares the parallel data b0 to b18 with the synchronization code pattern supplied from the reference data portion 20 to output the synchronization signal detecting output C as “1” in a timing recognized as the synchronization code. Here, expansion is performed by one bit before and after the pattern detecting circuit, respectively, to perform 19-bit comparison.

Here, FIG. 3 shows one example of a truth value table indicating an operation of the pattern match circuit. In FIG. 3, a normal signal P11 to be detected is the frame synchronization code signal. On the contrary, the signal P11 is an example of complete match;
a signal P12 is an example where a first symbol “1” is advanced by one symbol in timing;
a signal P13 is an example where the first symbol “1” is delayed by one symbol in timing;
a signal P14 is an example where a second symbol “1” is advanced by one symbol in timing;
a signal P15 is an example where the second symbol “1” is delayed by one symbol in timing;
a signal P16 is an example where a third symbol “1” is advanced by one symbol in timing; and
a signal P17 is an example where the third symbol “1” is delayed by one symbol in timing.

On the contrary, as shown in FIG. 3, the synchronization signal detecting outputs C are assumed as “1”, respectively, and a determination result of the match determining portion 31 is output as detection of the pattern frame synchronization code signal.

Further, as to a deviation of the symbol and a match number of the symbol,

the signal P11 has the deviation of “0” and the match number of “3”;
the signal P12 has the deviation of “1” and the match number of “2”;
the signal P13 has the deviation of “1” and the match number of “2”;
the signal P14 has the deviation of “1” and the match number of “2”;
the signal P15 has the deviation of “1” and the match number of “2”;
the signal P16 has the deviation of “1” and the match number of “2”; and
the signal P17 has the deviation of “1” and the match number of “2”.
   Signals other than the above signals have the match number of “1” or less and the synchronization signal detecting output C of “0”, and a determination result is obtained that the read signal does not match the frame synchronization code signal.

When the pattern frame synchronization code signal is detected using the Hamming distance in the patent literature 1 of the prior art for reference, the signals P11 to P17 in FIG. 3 are detected as the pattern frame synchronization code signals. A signal such as signal P2 or P3, whose symbol is present on b13 or b8, is obtained not by the fact the frame synchronization code signal is deviated in the decode processing of the binary decoding portion 12 but by the fact the general recording signal incidentally resembles the signal arrangement of the frame synchronization code signal so that it is absolutely irrelevant to the frame synchronization code signal. The detection in the patent literature 1 simply permits a mismatch of symbols, and permits one or two mismatched symbols, for example. Therefore, since even the signal such as the signal P2 or P3 absolutely irrelevant to the frame synchronization code signal is erroneously detected and is output as the frame synchronization code signal, the decode processing is confused in the following ETM decoding portion 15 or the like.

On the other hand, in the operation of detecting the frame synchronization code signal C in the deviation-containing synchronization detecting portion 14 according to the present invention, the deviation is permitted only by one symbol in consideration of the deviation between the symbol of the normal frame synchronization code signal and the symbol position of the read signal so that the recording signal is not erroneously determined as the frame synchronization code signal unlike conventionally.

(Two Forms of Determining Portion 31)

At least two forms are considered as the form of the deviation-containing match determining portion 31 which is the deviation-containing synchronization detecting portion 14 according to the present invention.

The first form is a method where the deviation-containing match determining portion 31 stores the signals P11 to P17 in FIG. 3, for example, from the reference data portion 20 and sequentially compares these signals with the read signal. When the read signal completely matches one of the signals P11 to P17, the synchronization signal detecting output C is output as “1” to the ETM decoding portion 15 as the detection of the frame synchronization code signal from the read signal.

In this case, a permissible range of the deviation can be changed by increasing signals where one deviation of the three symbols is halved not only the signals P11 to P17 or decreasing the signals P11 to P17 as the reference data stored in the reference data portion 20. Alternatively, it is preferable that a change reference is defined and reference changing is automated by the method described later.

The second form is a method where the deviation-containing match determining portion 31 is supplied with only the signal P11 which is the normal frame synchronization code signal from the reference data portion 20 and compares the signal P11 with only the read signal to sequentially obtain and evaluate the deviation of the symbol and the match number of the symbol. In other words, when the deviation of the symbol is assumed as “1” and the match number of the symbol is defined as “2 or more”, the read signal is substantially determined as the frame synchronization code signal when it is the signal P11 to P17 in FIG. 3. Therefore, the operation of the determining portion 31 can be realized even by a function of determining the deviation between the read signal and the normal frame synchronization code signal and a function of determining the match number.

Other form of the determining portion 31 may be one shown in FIG. 4. In other words, FIG. 4 shows the truth value table indicating the operation of the pattern match circuit, and the first row of this truth value table indicates a detection of the normal synchronization code. The synchronization signal detecting output C is assumed as “1” of the synchronization code as to the pattern deviated by one before or after “1” among the two is before and after the longest pattern among the three “1”s in the normal synchronization code.

In this example, the pattern match circuit is constituted paying attention to only before and after the easily variable longest pattern, and is smaller in the circuit size than the form shown in FIG. 3, and has a characteristic where one-bit delay does not occur in detection timing.

(In Case of Changing Deviation)

There will be described with reference to a flowchart in FIG. 11 a case where the deviation is changed depending on a detection rate of the frame synchronization code signals in the determining portion 31 according to the present invention. In the flowchart in FIG. 11, frame synchronization code signals are detected from a read signal using the reference data with the deviation of 0 by the processing of the deviation-containing match determining portion 31 (S11). Next, a detection rate of the frame synchronization code signals is obtained (S12), and when the detection rate of the frame synchronization code signals is lower than a predetermined value (arbitrarily set) (S13), the reference data is changed to reference data with the deviation of 1 (signals P12 to P17 in FIG. 3) to redetect the frame synchronization code signals (S14).

Further, the detection rate of the frame synchronization code signals is obtained (S15), and when the detection rate of the frame synchronization code signals is lower than the predetermined value (arbitrarily set) (S16), the reference data is changed to reference data with the deviation of 2 to redetect the frame synchronization code signals (S17). In this manner, the deviation of the reference data is changed depending on a magnitude of the detection rate so that the deviation is changed to 0 for a disk which is easy to detect the frame synchronization code signals or the deviation is changed to 1 or 2 for a disk which is difficult to detect the same. Thus, erroneous determination can be completely eliminated from the disk which is easy to detect the frame synchronization code signals and even the disk which is difficult to detect the frame synchronization code signals can appropriately detect the signals, so that a stable reproduction processing can be performed for any disk.

As shown in a flowchart in FIG. 12, the reference data with the deviation of 0 is used to detect the frame synchronization code signals from the read signal by the processing of the deviation-containing match determining portion 31 (S21). Next, the detection rate of the frame synchronization code signals is obtained (S22), and when the detection rate of the frame synchronization code signals is lower than the predetermined value (arbitrarily set) (S23), the deviation of the reference data is determined based on at least one of physical format information, that is, disk type, version, disk size, layer quantity, track path direction, presence of areas for ROM, RAM, and R, recording density, track density, start sector number, end sector number, and presence of BCA in a control data area as shown in FIG. 13. Then, the determined reference data is used to redetect the frame synchronization code using determined reference data (S24).

In this manner, the optimal deviation can be set based on the physicality of the optical disk, and the stable detection of the frame synchronization code signals and the reproduction processing based thereon are enabled depending on the characteristics of the optical disk.

Though those skilled in the art can realize the present invention from various embodiments described above, those skilled in the art can easily conceive various variants of these embodiments and can apply to various embodiments without inventive ability. Therefore, the present invention covers a wide range which does not contradict disclosed principles and novel characteristics, and is not limited to the aforementioned embodiment.

1. A disk apparatus comprising:
a reading portion which reads out frame synchronization codes and main data stored in a disk to output a read signal;
a detecting portion which determines that part of the read signal is identical to a frame synchronization code signal or determines that a deviation between a symbol of part of the read signal and a symbol of the frame synchronization code signal is within a certain time range, so as to detect the frame synchronization code signals from the read signal; and
a reproducing portion which reproduces the read signal read by the reading portion in synchronization with the frame synchronization code signals detected by the detecting portion.

2. A disk apparatus according to claim 1, wherein the detecting portion determines whether or not a deviation between a symbol of the read signal and a symbol of a normal frame synchronization code signal is within a certain time range and a difference between the symbol quantity of the read signal and the symbol quantity of the normal frame synchronization code signal is within a certain value.

3. A disk apparatus according to claim 1, wherein the detecting portion prepares a symbol of a normal frame synchronization code signal and a symbol having a certain time deviation for the symbol to determine whether or not one of the symbols matches the symbol of the read signal.

4. A disk apparatus according to claim 1, wherein the detecting portion prepares a symbol of a normal frame synchronization code signal and a symbol having a time deviation by one symbol for the symbol to determine whether or not one of the symbols matches the symbol of the read signal.

5. A disk apparatus according to claim 1, wherein the detecting portion prepares a symbol of a normal frame synchronization code signal and a symbol having a time deviation by 1 symbol or 2 symbols for the symbol to determine whether or not one of the symbols matches the symbol of the read signal.

6. A disk apparatus according to claim 1, wherein the detecting portion initially sets the certain time to zero, and when a detection rate of detecting the frame synchronization code signals from the read signal is lower than a predetermined value, expands the certain time range to a value larger than zero to determine whether or not a time deviation between the symbol of the read signal and the symbol of the normal frame synchronization code signal is within the expanded time range.

7. A disk apparatus according to claim 1, wherein when a detection rate of detecting the frame synchronization code signals from the read signal is lower than a predetermined value, the detecting portion expands the certain time range to a larger value and determines whether or not a time deviation between the symbol of the read signal and the symbol of the normal frame synchronization code signal is within the expanded time range.

8. A disk apparatus according to claim 1, wherein when a detection rate of detecting the frame synchronization code signals from the read signal is lower than a predetermined value, the detecting portion expands the certain time to a value determined based on information stored in control data on the disk and determines whether or not a time deviation between the symbol of the read signal and the symbol of the normal frame synchronization code signal is within the expanded time range.

9. A disk apparatus according to claim 1, wherein the detecting portion expands the certain time to a value determined based on information stored in control data on the disk and determines whether or not a time deviation between the symbol of the read signal and the symbol of the normal frame synchronization code signal is within the expanded time range.

10. A disk apparatus according to claim 1, wherein the detecting portion determines the certain time based on at least one of disk type, version, disk size, layer quantity, track path direction, presence of areas for ROM, RAM and R, recording density, track density, start sector number, end sector number, and presence of BCA which are a physical format of the control data on the disk.

11. A reproducing method comprising:
reading a read signal from a disk storing therein frame synchronization codes and main data;
determining that part of the read signal is identical to a frame synchronization code signal or determining that a deviation between a symbol of part of the read signal and a symbol of the frame synchronization code signal is within a certain time range, so as to detect the frame synchronization code signals from the read signal; and
reproducing the read signal in synchronization with the detected frame synchronization code signals.

12. A reproducing method according to claim 11, further comprising determining whether or not a deviation between the symbol of the read signal and the symbol of the normal frame synchronization code signal is within a certain time range and a difference between the symbol quantity of the read signal and the symbol quantity of the normal frame synchronization code signal is within a certain value.

13. A reproducing method according to claim 11, further comprising preparing a symbol of a normal frame synchronization code signal and a symbol having a certain time deviation for the symbol to determine whether or not one of the symbols matches the symbol of the read signal.

14. A reproducing method according to claim 11, further comprising preparing a symbol of a normal frame synchronization code signal and a symbol having a time deviation by one symbol for the symbol to determine whether or not one of the symbols matches the symbol of the read signal.

15. A reproducing method according to claim 11, further comprising preparing a symbol of a normal frame synchronization code signal and a symbol having a time deviation by 1 symbol or 2 symbols for the symbol to determine whether or not one of the symbols matches the symbol of the read signal.

16. A reproducing method according to claim 11, wherein the certain time is initially set to zero, and when a detection rate of detecting the frame synchronization code signals from the read signal is lower than a predetermined value, the certain time range is expanded to a value larger than zero to determine whether or not a time deviation between the symbol of the read signal and the symbol of the normal frame synchronization code signal is within the expanded time range.

17. A reproducing method according to claim 11, wherein when a detection rate of detecting the frame synchronization code signals from the read signal is lower than a predetermined value, the certain time range is expanded to a larger value to determine whether or not a time deviation between the symbol of the read signal and the symbol of the normal frame synchronization code signal is within the expanded time range.

18. A reproducing method according to claim 11, wherein when a detection rate of detecting the frame synchronization code signals from the read signal is lower than a predetermined value, the certain time is expanded to a value determined based on information stored in control data on the disk to determine whether or not a time deviation between the symbol of the read signal and the symbol of the normal frame synchronization code signal is within the expanded time range.

19. A reproducing method according to claim 11, wherein the certain time is expanded to a value determined based on information stored in control data on the disk to determine whether or not a time deviation between the symbol of the read signal and the symbol of the normal frame synchronization code signal is within the expanded time range.

20. A reproducing method according to claim 11, wherein the certain time is determined based on at least one of disk type, version, disk size, layer quantity, track path direction, presence of areas for ROM, RAM, and R, recording density, track density, start sector number, end sector number, and presence of BCA which are a physical format of the control data on the disk.
